(19) United States
(12) Patent Application Publication
(10) Pub. No.: US 2026/0276920 A1
(43) Pub. Date: Sep. 17, 2026

(54) OPTICAL COUPLING DEVICE AND OPTICAL TRANSMISSION UNIT

(71) Applicant: AIP Inc., New Taipei City (TW)

(72) Inventor: Chia LEE, New Taipei City (TW)

(21) Appl. No.: 19/241,801

(22) Filed: Jun. 18, 2025

Related U.S. Application Data
(60) Provisional application No. 63/770,037, filed on Mar. 11, 2025.

(51) Int. Cl. G02B 6/42

(52) U.S. Cl. CPC G02B 6/425; G02B 6/4292

(57) ABSTRACT

An optical coupling device includes a base and a plurality of lens elements. The base includes a bottom board, two side portions disposed on opposite ends of the bottom board, a main wall disposed between the two side portions and defining a plurality of positioning holes, and at least one front groove located between the two side portions and facing a front of the positioning holes. The lens elements are arranged on the bottom board in the at least one front groove. Each of the lens elements is positioned in alignment with a corresponding one of the positioning holes. An optical cable is positioned to and detachably connected to the side portions of the base such that a plurality of optical fibers included in the optical cable are optically aligned with the lens elements respectively.

### CROSS REFERENCE TO RELATED APPLICATIONS

This application claims the benefit of U.S. provisional patent application Ser. No. 63/770,037, filed Mar. 11, 2025, the entirety of which is incorporated by reference herein.

### BACKGROUND OF INVENTION

### 1. Field of Invention

The present invention relates to optical couplers, and particularly to an optical coupling device and an optical transmission unit.

### 2. Background

When a laser array is connected to a fiber array, lens and isolators are assembled only one pair at a time with a channel in the laser array and a fiber in the fiber array in prior art. After the laser array is activated to verify whether a maximum luminosity passes through the lens, the isolator, and one fiber of the fiber array, the lens and the isolator are secured with the laser array and the fiber array. Then go to assemble the next lens and the isolator with the next channel in the laser array. Such a process is very cumbersome and time-consuming. If a lens or isolator breaks down during operation, it is very difficult to replace the individual components with such a structure. Therefore, the entire set must be discarded.

### SUMMARY OF INVENTION

An object of the present application is to provide an optical coupling device, capable of being repeatedly connected with an optical cable and meeting the requirements of modular production.

Another object of the present application is to provide an optical transmission unit, capable of preventing the need to align each lens element individually with light emitters.

To achieve the above-mentioned object, the present application provides an optical coupling device, adapted for use with an optical cable, and including a base and a plurality of lens elements. The base includes a bottom board, two side portions disposed on opposite ends of the bottom board, a main wall disposed between the two side portions and defining a plurality of positioning holes, and at least one front groove located between the two side portions and facing a front of the positioning holes. The lens elements are arranged on the bottom board in the at least one front groove. Each of the lens elements is positioned in alignment with a corresponding one of the positioning holes. The optical cable is positioned to and detachably connected to the side portions of the base such that a plurality of optical fibers included in the optical cable are optically aligned with the lens elements respectively.

Optionally, the optical coupling device further includes a plurality of optical isolators. The base further includes at least one rear groove located between the two side portions and facing a rear of the positioning holes. The optical isolators are arranged on the bottom board in the at least one rear groove. Each of the optical isolators is positioned in alignment with a corresponding one of the positioning holes and a corresponding one of the lens elements.

Optionally, a plurality of front grooves are located corresponding to the positioning holes respectively, and the base further includes a plurality of partition walls positioned between adjacent ones of the plurality of front grooves and adjacent ones of the positioning holes.

Optionally, a plurality of rear grooves are located corresponding to the positioning holes respectively, and the plurality of partition walls extend to be positioned between adjacent ones of the plurality of rear grooves.

Optionally, the main wall and the side portions are integrally formed as one piece with the bottom board.

Optionally, the optical coupling device further includes a housing. The housing includes a support portion and a bent portion extending and bent upward from the support portion. A hollow opening is located at the bent portion. A support space is located on the support portion and communicates with the hollow opening. The base is positioned on the support portion. The lens elements adjoin the hollow opening.

Optionally, the housing further includes a cover portion disposed on a side of the bent portion opposite to the support space and located above the support portion. The bent portion is connected between the cover portion and the support portion. A recessed portion is defined between the bent portion and the cover portion and located on the side of the bent portion opposite to the support space. The recessed portion communicates with the support space through the hollow opening.

Optionally, the cover portion extends to the support space, and the base is located under the cover portion.

Optionally, the housing further includes a cover portion disposed on an end of the bent portion opposite to the support portion, the support space is formed between the support portion and the cover portion, and the base is located under the cover portion in the support space.

Optionally, a plurality of fastening portions are positioned on the side portions respectively. The optical cable includes a connecting head including a plurality of fastening elements, and the fastening elements are detachably fastened with the fastening portions.

The present application further provides an optical transmission unit, adapted for use with a light source device, and including an optical coupling device and an optical cable. The optical coupling device includes a base, a plurality of lens elements, and a plurality of optical isolators. The base includes a bottom board, two side portions disposed on opposite ends of the bottom board, and a plurality of fastening portions positioned on the side portions respectively. The lens elements are arranged on the bottom board between the side portions and positioned in optical alignment with a plurality of light emitters included in the light source device. The optical isolators are arranged to correspond to the lens elements on the bottom board. The optical cable includes a plurality of optical fibers and a connecting head disposed on ends of the optical fibers. The connecting head includes a plurality of fastening elements detachably fastened with the fastening portions of the base.

Optionally, the base further includes a main wall disposed between the two side portions and defining a plurality of positioning holes, a plurality of front grooves are located between the two side portions and face a front of the positioning holes respectively, and a plurality of the rear grooves are located between the two side portions and face a rear of the positioning holes respectively. The lens elements are arranged in the front grooves respectively, and the optical isolators are arranged in the rear grooves respectively.

Optionally, the base further includes a plurality of partition walls positioned between adjacent ones of the front grooves and adjacent ones of the rear grooves.

In the present application, the optical coupling device achieves the modular design for the lens elements and the optical isolators, thereby providing a modular optical coupling device to connect the laser array with the fiber array at a time and preventing the time-consuming process of aligning each lens element individually with the light emitters of the light source device. In addition, the modular design enables the optical coupling device and the optical cable to be fabricated on production lines separate from the light source device, thereby improving production efficiency.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic perspective view of an optical coupling device in accordance with an embodiment of the present application.

FIG. 2 is a schematic exploded view of the optical coupling device of FIG. 1.

FIG. 3 is a schematic exploded view of an optical coupling device and an optical cable that serve as an optical transmission unit, and a light source device.

FIG. 4 is a schematic assembly of the optical coupling device, the optical cable, and the light source device of FIG. 3.

FIG. 5 is a schematic bottom-front exploded perspective view of an optical transmission unit in accordance with an embodiment of the present application.

FIG. 6 is a schematic cross-sectional view FIG. 4.

FIG. 7A is a schematic perspective view showing a process the optical transmission unit to be coupled to the light source device.

FIG. 7B is a schematic perspective view showing an optical cable is detached after the assembly of the optical transmission unit and the light source device.

FIG. 8 is another schematic exploded perspective view of an optical transmission unit with a light source device in accordance with an embodiment of the present application.

FIG. 9A is a schematic bottom-front perspective view of an assembly of a housing and a base in accordance with an embodiment of the present application.

FIG. 9B is a schematic bottom-front perspective view of an assembly of a housing and a base in accordance with an embodiment of the present application.

FIG. 9C is a schematic bottom-front perspective view of an assembly of a housing and a base in accordance with an embodiment of the present application.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present application.

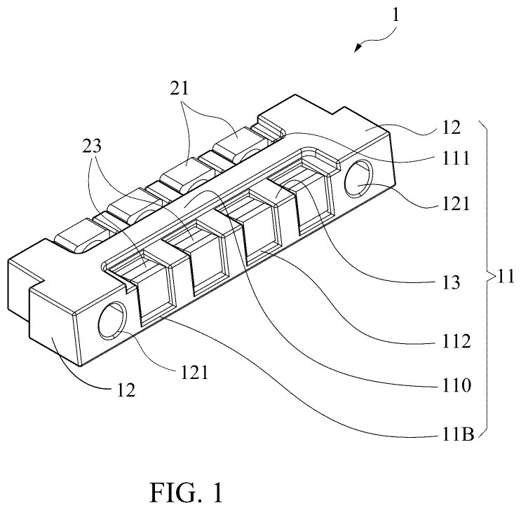

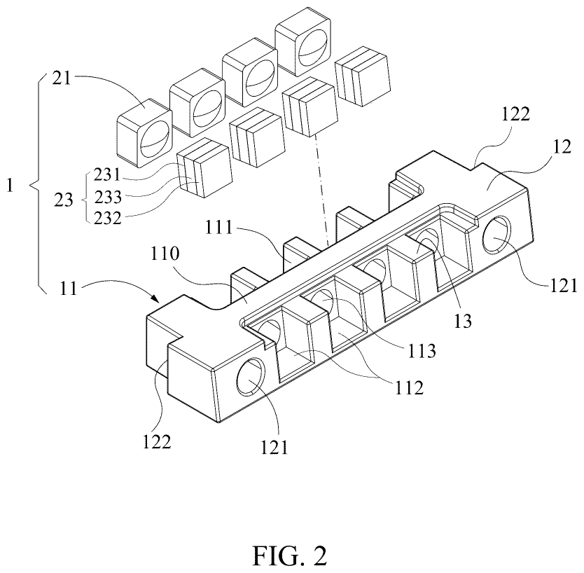

In one aspect, the present application provides an optical coupling device adapted for optical coupling with a light source device, serving to transmit light signals for data processing devices, such as switches or servers. Referring to FIGS. 1 and 2, FIG. 1 is a schematic perspective view of an optical coupling device 1 according to one embodiment of the present application, and FIG. 2 is a schematic exploded view of the optical coupling device 1 of FIG. 1. The optical coupling device 1 includes a base 11, a plurality of lens elements 21, and a plurality of optical isolators 23. In some embodiments, the base 11 includes a bottom board 11B, a main wall 110, two side portions 12, and a plurality of partition walls 13. Specifically, the main wall 110 is positioned on a substantial middle of the bottom board 11B, and the two side portions 12 are formed on opposite ends of the main wall 110 such that the two side portions 12 and the main wall 110 are jointly formed as a widened H-like frame. The partition walls 13 extend laterally from opposite sides of the main wall 110 in opposite directions. In detail, a plurality of the partition walls 13 are disposed on a front side of the main wall 110, and the other partition walls 13 are disposed on a rear side of the main wall 110. As shown in FIG. 2, the partition walls 13 are evenly arranged in parallel with each other from the front surface and the rear surface of the main wall 110.

As shown in FIGS. 1 and 2, each of the side portions 12 defines a fastening portion 121. In this embodiment, the fastening portion 121 is a slot, which extends through the side portion 12 and is exposed to outside. In some embodiments, the base 11 may be made of material having the characteristics of high temperature resistance, such as ceramic or metal. The main wall 110 and the side portions 12 are integrally formed as one piece with the bottom board 11B. Preferably, the main wall 110, the side portions 12, the partition walls 13, and the bottom board 11B are integrally formed into one-piece element. As shown in FIG. 2, in this embodiment, two engaging notches 122 are formed on the side portions 12 respectively. Specifically, a corner portion of each of the side portions 12 is notched to form the engaging notch 122.

Still referring to FIGS. 1 and 2, a plurality of front grooves 111 are formed between the two side portions 12 and the front surface of the main wall 110 and arranged in a row, and a plurality of rear grooves 112 are formed between the two side portions 12 and the rear surface of the main wall 110 and arranged in a row. As shown in FIG. 2, a plurality of positioning holes 113 are formed in the main wall 110 and connected between the front grooves 111 and the rear grooves 112 respectively. Specifically, each of the partition walls 13 is located between adjacent ones of the front grooves 111, adjacent ones of the rear grooves 112, and adjacent ones of the positioning holes 113. As shown in FIG. 2, the end one of the front grooves 111 and the rear grooves 112 in their array are bounded by the side portions 12 respectively.

As shown in FIGS. 1 and 2, the lens elements 21 are arranged in the respective front grooves 111 to function as a lens array, and the optical isolators 23 are arranged in the rear grooves 112 to function as an isolator array. The number of the front grooves 111 and the rear grooves 112 are determined according to the number of the lens elements 21 and the optical isolators 23. The lens elements 21 may be fabricated using a variety of optical materials, including fused silica, different types of glass, plastics, or polymers. Specifically, each of the lens elements 21 includes a lens, which is preferably round, or cylindrical in shape suitable for high-power lasers. For example, the laser has a laser power greater than 500 milliwatts (mW). In this embodiment, the lens elements 21 are configured to couple high power laser. When light passes through each of the lens elements 21, the lens element 21 collects and focuses the incoming light onto a specific point in space, so as to focus and redirect light.

Referring to FIG. 2, the optical isolators 23 are configured to block return light signals directed by the lens elements 21 and enable light transmission in a desired direction by polarization rotation. In some embodiments, each of the optical isolators 23 mainly includes an input polarization element 231, an output polarization element 232, and an optical rotator 233 disposed between the input polarization element 231 and the output polarization element 232. Since the working principle of the optical isolator 23 is known to those skilled in the art, it will not be described in detail here. Specifically, the optical isolator 23 is configured to enable the light from the lens element 21 to propagate in a desired direction and reduce interference caused by reflected light, thereby exhibiting a relatively low propagation loss in the desired direction.

As described above, by means of the base 11 serving as a frame platform, the lens elements 21 and the optical isolators 23 can be quickly positioned in optical alignment with each other on the base 11, thereby reducing the difficulty of alignment and assembly and improving production efficiency because the optical coupling device 1 is separately prepared from other devices.

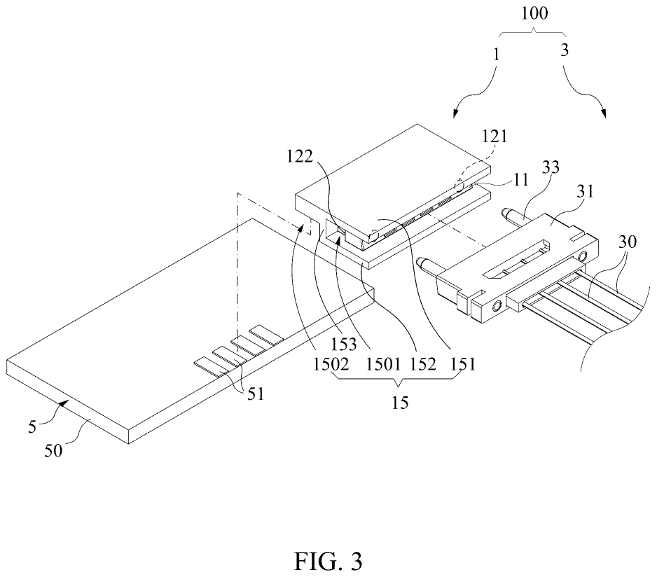

Referring to FIG. 3 in combination with FIGS. 1 and 2, FIG. 3 is a schematic exploded view of the optical coupling device 1 and an optical cable 3 that serve as an optical transmission unit 100 for use with a light source device 5 in accordance with an embodiment of the present application. As shown in FIG. 3, the optical transmission unit 100 includes the optical coupling device 1 and the optical cable 3 detachably connected to the optical coupling device 1. As shown in FIG. 3, the optical cable 3 includes a plurality of optical fibers 30, a connecting head 31, and a plurality of fastening elements 33 detachably fastened with the fastening portions 121. The connecting head 31 is installed to ends of the optical fibers 30 to terminate the optical fibers 30, and the fastening elements 33 are disposed on a front surface of the connecting head 31.

Still referring to FIG. 3, in this embodiment, the fastening elements 33 protrude and extend frontward from the connecting head 31. Specifically, the fastening elements 33 are peg-like in shape and are insertable to the fastening portions 121. It should be noted that the shapes of the fastening elements 33 and the fastening portions 121 are not limited thereto. In some other embodiments, the fastening elements 33 and the fastening portions 121 may be fastened together through hook structures (not shown) as long as the optical coupling device 1 and the optical cable 3 can be securely connected while the optical coupling device 1 and the optical cable 3 remain the design of detachable connection. In other embodiments, as shown in FIGS. 2 and 3, the engaging notches 122 formed on the side portions 12 of the base 11 are provided for being engaged with hook structures (not shown) of the connecting head 31 to enhance the secure connection between the base 11 and the connecting head 31.

As shown in FIG. 3, the optical coupling device 1 further includes a housing 15 sized and shaped to support the base 11. Specifically, the housing 15 includes a cover portion 151, a support portion 152, and a bent portion 153. The bent portion 153 extends and bends upward from the support portion 152 and is connected between the cover portion 151 and the support portion 152.

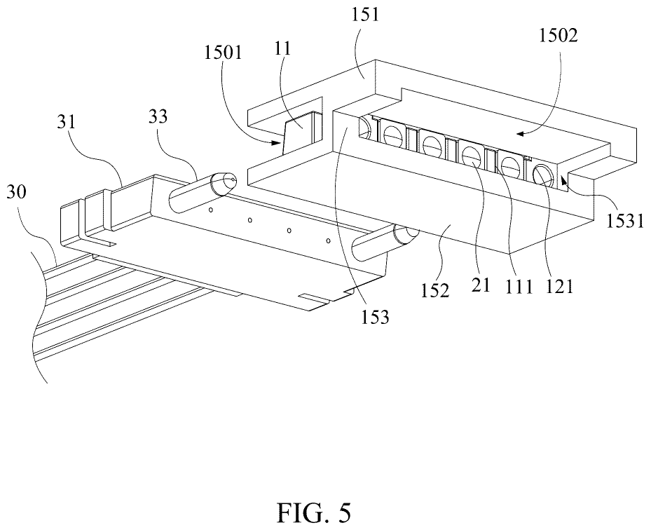

Referring to FIG. 5 in combination with FIG. 3, FIG. 5 is a schematic bottom-front exploded perspective view of the optical transmission unit 100. A support space 1501 is located on the support portion 152 and formed between the cover portion 151 and the support portion 152 to accommodate the base 11. In this embodiment, the cover portion 151 extends to the support space 1501, and the base 11 is located under the cover portion 151 so that the base 11 with the lens elements 21 and the optical isolators 23 can be protected by the cover portion 151. Specifically, as shown in FIG. 5, the bent portion 153 forms a hollow opening 1531 adjoining the front grooves 111 and being exposed to outside. In detail, the bent portion 153 is substantially perpendicular to the cover portion 151 and forms a recessed portion 1502 with the cover portion 151. The recessed portion 1502 is defined between the bent portion 153 and the cover portion 151 and located on the side of the bent portion 153 opposite to the support space 1501 in such a way that the recessed portion 1502 communicates with the support space 1501 and is positioned close to the light source 5.

Still referring to FIG. 3, the light source device 5 includes a load board 50 and a plurality of light emitters 51. The light emitters 51 are disposed on the load board 50 and are flush with each other. In some embodiments, the light emitters 51 are high power laser emitters and may be, for example, such as gallium arsenide (GaAs) laser diodes, gallium nitride (GaN) laser diodes, or indium gallium arsenide phosphide (InGaAsP) laser diodes, but are not limited thereto. The load board 50 may be mounted on an optoelectronic integrated circuit (not shown) in a data processing device, such as a switch. It should be noted that a pitch of adjacent lens elements 21 is pre-determined according to a pitch of adjacent light emitters 51.

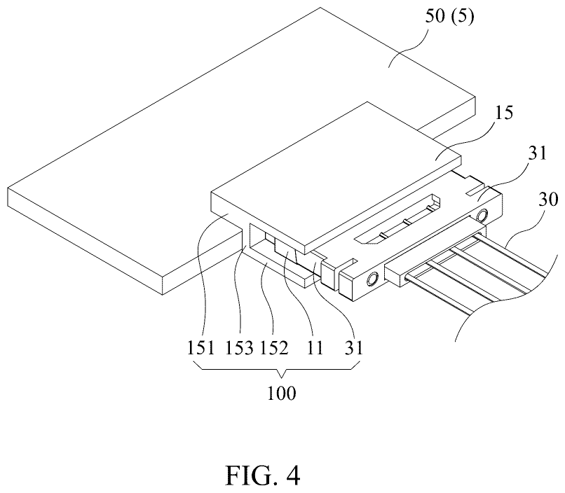

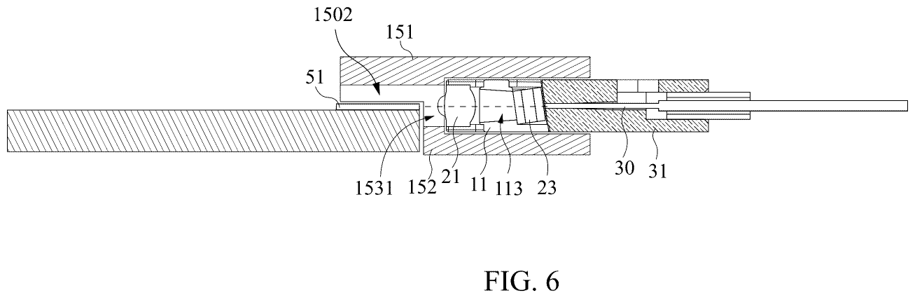

Referring to FIGS. 3 to 6, FIG. 4 is a schematic assembly of the optical coupling device 1. the optical cable 3, and the light source device 5, and FIG. 6 is a schematic cross-sectional view FIG. 4. As shown in FIGS. 3 and 4, the optical transmission unit 100 is optically mounted on the light source device 5 to transmit light signals from the light emitters 51 to at least an applied product. In assembly, as shown in FIG. 4, the bent portion 153 of the housing 15 is located adjacent to an edge of the load board 50, where part of the load board 50 is in the recessed portion 1502 with the cover portion 151 shielded over the light emitters 51. As shown in FIG. 6, in this embodiment, the light emitted by the light emitters 51 (laser emitters) travels in a straight direction (as indicated by the horizontal hidden line shown in FIG. 6) to pass through the lens elements 21 and is directed first by the lens elements 21, then the light travels through the positioning holes 113 to strike the optical isolators 23, and is finally transmitted in a desired direction to the optical fibers 30, thereby efficiently reducing the light signal loss during transmission.

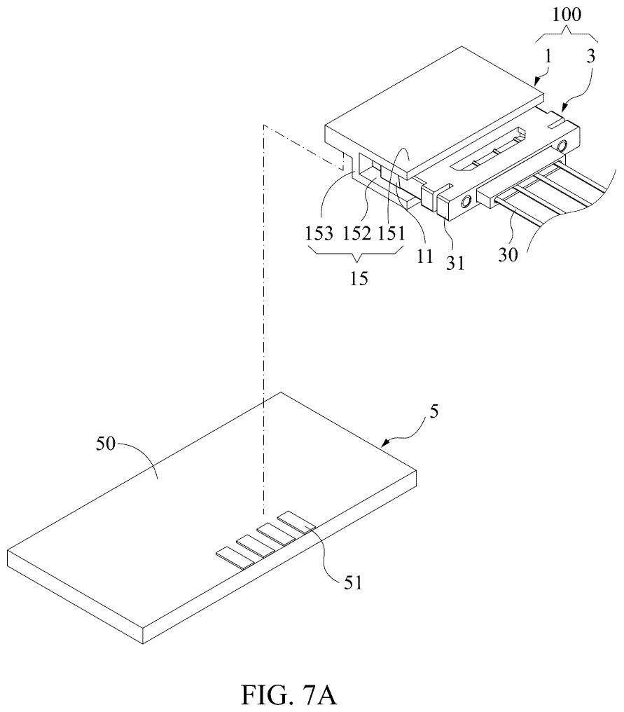

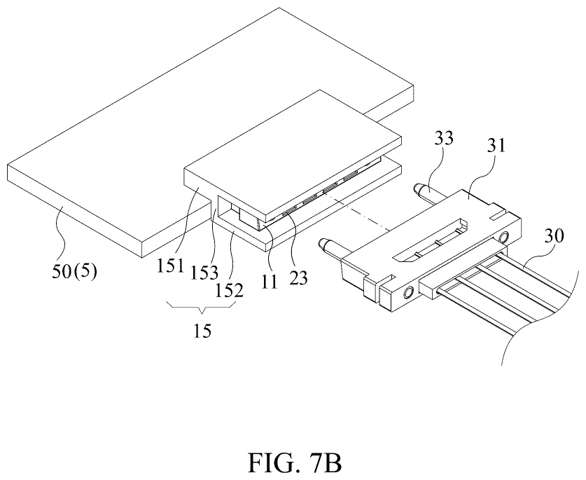

Referring to FIGS. 7A and 7B, illustrating a process of the optical transmission unit 100 to be coupled to the light source device 5, as shown in FIG. 7A, prior to be mounted on the load board 50, the base 11 installed with the lens elements 21 and the optical isolators 23 is firstly connected with the optical cable 3 to serve as the optical transmission unit 100. In detail, the optical cable 3 is easily plugged to the base 11 so that the optical fibers 30, the lens elements 21, and the optical isolators 23 are in optical alignment with one another (as shown in FIG. 6). Then, as shown in FIG. 7A, the optical transmission unit 100 is to be optically coupled with the light source device 5.

Referring to FIG. 7B, after the optical transmission unit 100 including the lens elements 21, the optical isolators 23, and the optical fibers 30 are actively aligned with the light emitters 51 to enable light signal transmission between the light emitters 51 and the optical fibers 30, the housing 15 is being mounted on the load board 50. In doing so, the lens elements 21 can be prevented from being actively aligned with the light emitters 51 one by one. At this stage, the base 11 is precisely positioned to the light source device 5. Subsequently, the optical cable 3 may be detached from the base 11 and allowed to be reconnected to the base 11 repeatedly or replace the optical cable 3 with the same type, while maintaining the optical fibers 30 in the precise optical alignment for reception of the light signal without signal loss.

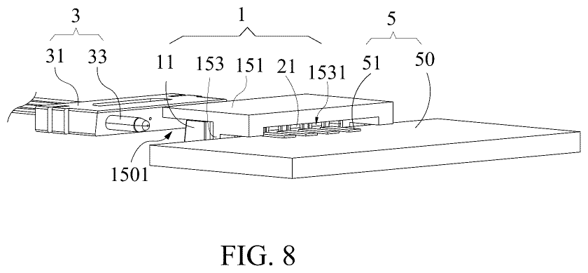

Referring to FIG. 8, illustrating a different exploded perspective views of the optical transmission unit 100, the optical coupling device 1 is positioned between the load board 50 and the optical cable 3. The base 11 is positioned in the support space 1501, the lens elements 21 are located by the hollow opening 1531 and face the light emitters 51, and the light emitters 51 are shielded by the cover portion 151.

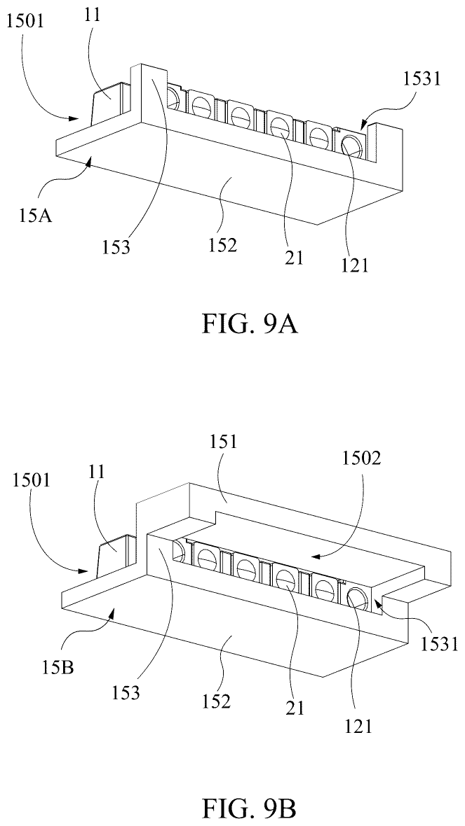

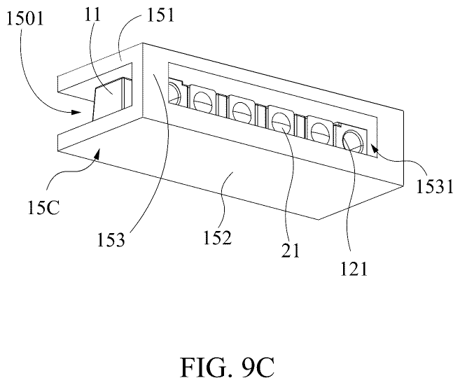

Referring to FIGS. 9A to 9C, each shows a schematic bottom-front perspective view of an assembly of a housing 15A, 15B, 15C and a base 11 in accordance with different embodiments of the present application. It should be noted that each of the housings 15A, 15B, 15C can be used with the above-mentioned optical cable 3 and the light source device 5. As shown in FIG. 9A, in this embodiment, the cover portion 151 is not provided. Specifically, the housing 15A includes a support portion 152 and a bent portion 153 extending and bent upward from the support portion 152, a hollow opening 1531 is located at the bent portion 153, a support space 1501 is located on the support portion 152 and communicates with the hollow opening 1531, the base 11 is positioned on the support portion 152, and the lens elements 21 adjoin the hollow opening 1531.

As shown in FIG. 9B, in this embodiment, part of the cover portion 151 over the support space 1501 as shown in FIG. 5 is omitted. Specifically, the housing 15B includes a cover portion 151 disposed on a side of the bent portion 153 opposite to the support space 1501 and located above the support portion 152. The bent portion 153 is connected between the cover portion 151 and the support portion 152. A recessed portion 1502 is defined between the bent portion 153 and the cover portion 151 and located on the side of the bent portion 153 opposite to the support space 1501. The recessed portion 1502 communicates with the support space 1501 through the hollow opening 1531.

As shown in FIG. 9C, in this embodiment, part of the cover portion 151 away from the support space 1501 as shown in FIG. 5 is omitted. Specifically, the housing 15C includes a cover portion 151 disposed on an end of the bent portion 153 opposite to the support portion 152, the support space 1501 is formed between the support portion 152 and the cover portion 151, and the base 11 is located under the cover portion 151 in the support space 1501.

In another aspect, the present application provides an optical transmission unit, adapted for use with the above-mentioned light source device, and including the above-mentioned optical coupling device including a base, a plurality of lens elements, and a plurality of optical isolators. The base includes a bottom board, two side portions disposed on opposite ends of the bottom board, and a plurality of fastening portions positioned on the side portions respectively. The plurality of lens elements are arranged on the bottom board between the side portions and positioned in optical alignment with a plurality of light emitters included in the light source device. The plurality of optical isolators arranged to correspond to the lens elements on the bottom board. An optical cable includes a plurality of optical fibers and a connecting head disposed on ends of the optical fibers. The connecting head includes a plurality of fastening elements detachably fastened with the fastening portions of the base.

Accordingly, the present application provides the optical coupling device and the optical transmission unit to achieve the modular design for the lens elements and the optical isolators, thereby providing a modular optical coupling device to connect the laser array with the fiber array at a time and preventing the time-consuming process of aligning each lens element individually with the light emitters of the light source device. In addition, the modular design enables the optical coupling device and the optical cable to be fabricated on production lines separate from the light source device, thereby improving production efficiency.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An optical coupling device, adapted for use with an optical cable, and comprising:
a base comprising a bottom board, two side portions disposed on opposite ends of the bottom board, a main wall disposed between the two side portions and defining a plurality of positioning holes, and at least one front groove located between the two side portions and facing a front of the positioning holes; and
a plurality of lens elements arranged on the bottom board in the at least one front groove, each of the lens elements positioned in alignment with a corresponding one of the positioning holes, and the optical cable positioned to and detachably connected to the side portions of the base such that a plurality of optical fibers included in the optical cable are optically aligned with the lens elements respectively.

2. The optical coupling device of claim 1, further comprising a plurality of optical isolators, wherein the base further comprises at least one rear groove located between the two side portions and facing a rear of the positioning holes, the optical isolators are arranged on the bottom board in the at least one rear groove, each of the optical isolators is positioned in alignment with a corresponding one of the positioning holes and a corresponding one of the lens elements.

3. The optical coupling device of claim 2, wherein a plurality of front grooves are located corresponding to the positioning holes respectively, and the base further comprises a plurality of partition walls positioned between adjacent ones of the plurality of front grooves and adjacent ones of the positioning holes.

4. The optical coupling device of claim 3, wherein a plurality of rear grooves are located corresponding to the positioning holes respectively, and the partition walls extend to be positioned between adjacent ones of the plurality of rear grooves.

5. The optical coupling device of claim 2, wherein the main wall and the side portions are integrally formed as one piece with the bottom board.

6. The optical coupling device of claim 2, further comprising a housing, wherein the housing comprises a support portion and a bent portion extending and bent upward from the support portion, a hollow opening is located at the bent portion, a support space is located on the support portion and communicates with the hollow opening, the base is positioned on the support portion, and the lens elements adjoin the hollow opening.

7. The optical coupling device of claim 6, wherein the housing further comprises a cover portion disposed on a side of the bent portion opposite to the support space and located above the support portion, the bent portion is connected between the cover portion and the support portion, a recessed portion is defined between the bent portion and the cover portion and located on the side of the bent portion opposite to the support space, and the recessed portion communicates with the support space through the hollow opening.

8. The optical coupling device of claim 7, wherein the cover portion extends to the support space, and the base is located under the cover portion.

9. The optical coupling device of claim 6, wherein the housing further comprises a cover portion disposed on an end of the bent portion opposite to the support portion, the support space is formed between the support portion and the cover portion, and the base is located under the cover portion in the support space.

10. The optical coupling device of claim 1, wherein a plurality of fastening portions are positioned on the side portions respectively, the optical cable comprises a connecting head comprising a plurality of fastening elements, and the fastening elements are detachably fastened with the fastening portions.

11. An optical transmission unit, adapted for use with a light source device, and comprising:
an optical coupling device comprising:
a base comprising a bottom board, two side portions disposed on opposite ends of the bottom board, and a plurality of fastening portions positioned on the side portions respectively; and
a plurality of lens elements arranged on the bottom board between the side portions and positioned in optical alignment with a plurality of light emitters included in the light source device;
a plurality of optical isolators arranged to correspond to the lens elements on the bottom board; and
an optical cable comprising a plurality of optical fibers and a connecting head disposed on ends of the optical fibers, and the connecting head comprising a plurality of fastening elements detachably fastened with the fastening portions of the base.

12. The optical transmission unit of claim 11, wherein the base further comprises a main wall disposed between the two side portions and defining a plurality of positioning holes, a plurality of front grooves are located between the two side portions and face a front of the positioning holes respectively, and a plurality of rear grooves are located between the two side portions and face a rear of the positioning holes respectively, wherein the lens elements are arranged in the front grooves respectively, and the optical isolators are arranged in the rear grooves respectively.

13. The optical transmission unit of claim 12, wherein the base further comprises a plurality of partition walls positioned between adjacent ones of the front grooves and adjacent ones of the rear grooves.

14. The optical transmission unit of claim 12, wherein the main wall and the side portions are integrally formed as one piece with the bottom board.

15. The optical transmission unit of claim 11, further comprising a housing, wherein the housing comprises a support portion and a bent portion extending and bent upward from the support portion, a hollow opening is located at the bent portion, a support space is located on the support portion and communicates with the hollow opening, the base is positioned on the support portion, and the lens elements adjoin the hollow opening.

16. The optical transmission unit of claim 15, wherein the housing further comprises a cover portion disposed on a side of the bent portion opposite to the support space and located above the support portion, the bent portion is connected between the cover portion and the support portion, a recessed portion is defined between the bent portion and the cover portion and located on the side of the bent portion opposite to the support space, and the recessed portion communicates with the support space through the hollow opening.

17. The optical transmission unit of claim 16, wherein the cover portion extends to the support space, and the base is located under the cover portion.

18. The optical transmission unit of claim 15, wherein the housing further comprises a cover portion disposed on an end of the bent portion opposite to the support portion, the support space is formed between the support portion and the cover portion, and the base is located under the cover portion in the support space.
